(19) United States
(12) Patent Application Publication
(10) Pub. No.: US 2025/0320155 A1
(43) Pub. Date: Oct. 16, 2025

(54) LOW WARP CHEMICALLY STRENGTHENED GLASS TEXTURED BY MODIFIED LASER AND ETCHING PROCESS

(71) Applicant: CORNING INCORPORATED, CORNING, NY (US)

(72) Inventors: David Eugene Baker, Bath, NY (US); Yuhui Jin, Painted Post, NY (US); Xinghua Li, Horseheads, NY (US); Lei Yuan, Painted Post, NY (US)

(21) Appl. No.: 18/712,278

(22) PCT Filed: Nov. 18, 2022
(86) PCT No.: PCT/US2022/050413

§ 371 Date: May 22, 2024

Related U.S. Application Data
(60) Provisional application No. 63/284,629, filed on Nov. 30, 2021.

(51) Int. Cl. C03C 23/00; C03C 15/00; C03C 21/00

(52) U.S. Cl. CPC C03C 23/0025; C03C 15/00; C03C 21/002

(57) ABSTRACT

An article includes a glass, glass-ceramic, or ceramic substrate having a first surface and a textured region comprising surface features defined by the first surface. The surface features each have a feature size and a feature position selectively controlled such that the surface features within at least one subregion of the textured region have a distribution of feature sizes and/or feature positions in at least one direction.

### CROSS-REFERENCE TO RELATED APPLICATIONS

This application claims the benefit of priority under 35 U.S.C. § 119 of U.S. Provisional Application No. 63/284,629, filed Nov. 30, 2021, the content of which is incorporated herein by reference in its entirety.

### FIELD

The present disclosure relates to textured substrates and, more particularly, to methods for texturing glass, glass-ceramic, and ceramic substrates using laser and chemical etch processes and to articles comprising glass, glass-ceramic, or ceramic substrates textured by such methods.

### BACKGROUND

Textured glass is used in many applications. In mobile consumer electronics, textured glass is sometimes used for anti-glare display covers and for anti-fingerprint and anti-slip non-display covers. Textured glass is especially useful for back cover applications since the textured glass does not attenuate 5G mobile device signals, improves surface touch sensation, and reduces the slipperiness of the glass surface. An important specification for back cover applications is drop performance. To improve drop performance of back cover applications, transparent glass ceramic materials have been considered since these materials have higher resistance to breakage after impact with the ground.

There are some challenges in texturing glass ceramic materials. Conventional glass texturing methods can include a wet chemical etching process or a sandblast and etch process. Both of these methods use hydrofluoric acid (HF) for etching and texturing the glass surfaces. FIGS. 9A-9C illustrate a typical sandblast and etch process performed on an article 900 that includes a glass, glass ceramic, or ceramic substrate 902 with a first surface 904 and an opposite second surface 906 that are not textured. First, sandblast media is directed at the substrate 902 to texture the first surface 904 by introducing a plurality of surface features 908, such as first, second, and third surface features 908a, 908b, and 908c in the form of damage and/or cracks therein (FIG. 9A). A possible issue from such texturing is the generation of non-uniform surface features 908 in the first surface 904. For example, compare the first surface feature 908a and second surface feature 908b, which are conceptually depicted as narrow and deep, to the third surface feature 908c, which is conceptually depicted as wide and shallow.

HF etching usually follows the sandblast texturing (FIG. 9B). The function of the HF etching is to repair the subsurface damage introduced by the sandblast texturing and to recover the surface strength of the sandblast-textured surface. However, to maximize strength recovery, a significant amount of substrate material from the sandblast-textured surface needs to be removed by the etching process, for example, about 20 μm. FIG. 9B conceptually illustrates the textured surface 904 after the HF etching, showing the surface features 908 enlarged due to the removal of substrate material in multiple dimensions as a result of surface contact with the HF etchant. The dimensional non-uniformity of the surface features 908 formed in the first surface 904 formed during the texturing step (FIG. 9A) can contribute to the larger amount of substrate material that needs to be etched to repair the subsurface damage. In addition to process-related concerns, the use of HF in industry has safety concerns and environmental concerns related to the exposure and discharge of the HF waste.

Existing alternative solutions to HF etching have some challenges. One solution includes the use of an alkali hydroxide solution to etch the textured surface. However, the etch rate of hydroxide etching is typically much slower than HF etching. For instance, when using a 10 wt % NaOH etchant in place of an HF etchant, the total etch time to remove 20 μm of glass ceramic surface to recover subsurface damage from sandblast etching can be more than 50 hours. Optionally, as shown in FIG. 9C, one or more surfaces of the textured and etched substrate 902 can be chemically strengthened via processes such as ion-exchange after the HF etching process. The chemical strengthening of the substrate 900 is shown schematically as a hatch pattern extending inwardly from the outer surfaces of the substrate 900.

Consequently, it would be advantageous to provide a method and an article formed from such a method that overcome these challenges.

### SUMMARY

According to aspect (1), an article is provided. The article comprises: a glass, glass-ceramic, or ceramic substrate having a first surface, and a textured region comprising a plurality of surface features defined by the first surface, a feature size and a feature position of each surface feature selectively controlled such that the surface features within at least one subregion of the textured region have a distribution of feature sizes and/or feature positions in at least one direction.

According to aspect (2), the article of aspect (1), wherein the surface features within the at least one subregion have the distribution of feature sizes and the feature sizes within the at least one subregion are uniform.

According to aspect (3), the article of aspect (2), wherein a standard deviation of feature size is about 50% or less to the average feature size of all surface features within the at least one subregion.

According to aspect (4), the article of aspect (2), wherein a standard deviation of feature size is about 20% or less to the average feature size of all surface features within the at least one subregion.

According to aspect (5), the article of any one of aspects (1) to (4), wherein the feature size is at least one of a width at the first surface and a depth from the first surface.

According to aspect (6), the article of aspect (5), wherein the width is a value in a range of from about 5 μm to about 100 μm.

According to aspect (7), the article of aspect (5), wherein the depth is a value in a range of from about 10 nm to about 10 μm.

According to aspect (8), the article of aspect (5), wherein a ratio of width to depth is about 5 or greater.

According to aspect (9), the article of aspect (1), wherein the surface features within the at least one subregion have the distribution of feature sizes, the feature sizes within the at least one subregion varying with respect to one or more of a width at the first surface and a depth from the first surface.

According to aspect (10), the article of any one of aspects (1) to (9), wherein the surface features within the at least one subregion have the distribution of feature positions and the feature positions within the at least one subregion are arranged in a pattern.

According to aspect (11), the article of aspect (10), wherein the surface features within the at least one subregion are discrete.

According to aspect (12), the article of aspect (10), wherein the surface features within the at least one subregion are continuous.

According to aspect (13), the article of any one of aspects (1) to (12), wherein: the at least one subregion comprises a first subregion and a second subregion, the surface features within the first subregion have a first distribution of feature sizes and/or feature positions, and the surface features with the second subregion have a second distribution of feature sizes and/or feature positions that is different than the first distribution of feature sizes and/or feature positions.

According to aspect (14), the article of aspect (13), wherein an attribute of the substrate within the textured region has a first value within the first subregion and a second value, different from the first value, within the second subregion.

According to aspect (15), the article of aspect (13), wherein the attribute is at least one of haze, transmittance, gloss, distinctness-of-image (DOI), average surface roughness, and root mean square surface roughness.

According to aspect (16), the article of aspect (15), wherein a first planar position of the first surface within the first subregion differs from a second planar position of the first surface within the second subregion by 2 μm or less in a direction normal to the first surface when the attribute is haze.

According to aspect (17), the article of aspect (15), wherein a first planar position of the first surface within the first subregion differs from a second planar position of the first surface within the second subregion by 1 μm or less in a direction normal to the first surface when the attribute is haze.

According to aspect (18), the article of any one of aspects (1) to (17), wherein the textured region is substantially free of subsurface cracks.

According to aspect (19), the article of any one of aspects (1) to (18), wherein a material of the substrate proximate to the first surface within the surface features is different than a bulk material spaced from the surface features.

According to aspect (20), the article of aspect (19), wherein the material is different than the bulk material with respect to one or more of chemical composition and phase.

According to aspect (21), the article of any one of aspects (1) to (20), wherein the glass, glass-ceramic, or ceramic substrate is chemically strengthened through the first surface and a second surface opposite the first surface, and wherein a total indicator reading (TIR) of the second surface is less than 20 μm for each 50 mm×50 mm surface portion of the smallest number of 50 mm×50 mm surface portions configured to encompass an entirety of the second surface.

According to aspect (22), the article of aspect (21), wherein the article comprises a flexural strength of at least 1.75 GPa based on ring on ring (RoR) testing.

According to aspect (23), a method of texturing an article is provided. The method comprises: heating a substrate that comprises a glass, glass-ceramic, or ceramic composition to a target temperature, directing pulsed radiation from a laser at a first surface of the substrate to form a plurality of surface features within a textured region, the surface features each having a feature size and a feature position defined by the pulsed radiation, and configuring the laser to emit the pulsed radiation to form a first subregion of surface features within the textured region, the surface features within the first subregion having a first distribution of feature sizes and/or feature positions in at least one direction.

According to aspect (24), the method of aspect (23), wherein heating the substrate comprises heating the substrate to a target temperature of at least 300° C.

According to aspect (25), the method of aspect (23), further comprising wet etching the substrate by exposing the first surface and a second surface opposite the first surface to an etchant.

According to aspect (26), the method of aspect (25), wherein the etchant comprises hydrofluoric acid.

According to aspect (27), the method of aspect (25), wherein the etchant comprises an aqueous hydroxide material.

According to aspect (28), the method of aspect (25), wherein the wet etching is configured to remove at most 20 μm from the first surface and a second surface of the substrate opposite the first surface.

According to aspect (29), the method of aspect (28), wherein the wet etching is configured to remove at most 5 μm from the first surface and the second surface.

According to aspect (30), the method of aspect (23), further comprising chemically strengthening the substrate through the first surface with the surface features and a second surface opposite the first surface.

According to aspect (31), the method of aspect (30), wherein chemically strengthening the substrate is accomplished by an ion-exchange medium comprising a molten alkali salt.

According to aspect (32), the method of aspect (23), wherein configuring the laser to emit the pulsed radiation to form the first subregion of surface features comprises setting one or more parameters of the laser, the parameters including a laser type, a center wavelength, a repetition rate, an average power, a pulse duration, a pulse energy, a beam shape, a focal length, a spot size, a scanning method, a scanning speed, a scanning pitch spacing, a scanning line spacing, and a laser fluence.

According to aspect (33), the method of aspect (32), further comprising configuring the laser to emit the pulsed radiation to form a second subregion of surface features within the textured region, the surface features within the second subregion having a second distribution of feature sizes and/or feature positions in the at least one direction that is different than the first distribution of feature sizes and/or feature positions.

According to aspect (34), the method of aspect (33), wherein configuring the laser to emit the pulsed radiation to form the second subregion of surface features comprises changing at least one of the one or more parameters of the laser.

According to aspect (35), a method of texturing an article is provided. The method comprises: heating a substrate that comprises a glass, glass-ceramic, or ceramic composition to a target temperature, directing pulsed radiation from a laser at a first surface of the substrate to form a plurality of surface features within a textured region, the surface features each having a feature size and a feature position defined by the pulsed radiation, and configuring the laser to emit the pulsed radiation to form at least one subregion of surface features within the textured region, the surface features within the at least one subregion having a continuous and random distribution of feature sizes and feature positions.

### BRIEF DESCRIPTION OF THE DRAWINGS

FIG. 1 is a perspective top view of a glass, glass-ceramic, or ceramic substrate depicting a surface;

FIG. 2 is a side view of the substrate of FIG. 1, illustrating the substrate having a thickness between the surface and a further surface;

FIG. 3 is a conceptual top view of a textured region on one of the surfaces of the substrate of FIG. 1, the textured region comprising surface features having a first configuration according to the embodiments of the present disclosure;

FIG. 4 is a conceptual top view of the textured region of FIG. 3 with the surface features having a second configuration different from the first configuration according to the embodiments of the present disclosure;

FIG. 5 is a conceptual cross-sectional side view of the substrate of FIG. 1 taken through line V-V of FIG. 3, depicting attributes of the surface features within a first subregion of the textured region;

FIG. 6 is a conceptual cross-sectional side view of the substrate of FIG. 1 taken through line VI-VI of FIG. 3, depicting attributes of the surface features within a second subregion of the textured region;

FIG. 7 is a conceptual top view of the textured region of FIG. 3 with the surface features having a third configuration different from the first and second configurations according to the embodiments of the present disclosure;

FIGS. 8A-8C are a stepwise series of cross-sectional representations of a substrate in various steps of a modified texturing and etching process to form a textured surface on the substrate according to embodiments of the present disclosure;

FIGS. 9A-9C are a stepwise series of cross-sectional representations of a substrate in various steps of a conventional texturing and etching process to form a textured surface on the substrate;

FIG. 10 are magnified images showing surface morphology changes after laser texturing with ultrafast laser (A, left) and composition/phase changes at the surface within the surface features (B, right);

FIG. 11 are images of six sample surfaces that were laser textured using the ultrafast laser with six different laser intensities, respectively;

FIG. 12 are images illustrating a glass ceramic surface textured with the ultrafast laser using 10 μJ/per pulse according to Example 1 prior to etching (A, left) and the same glass ceramic surface after etching (B, right);

FIG. 13 are images illustrating a glass ceramic surface textured with the CO₂ laser according to Example 2 prior to etching (A, left) and the same glass ceramic surface after etching (B, right);

FIG. 14 is a plot of the ring on ring test data from Example 4;

FIG. 15 is a plot of the ring on ring test data from Example 5; and

FIG. 16 are SEM images of CO₂ laser textured glass-ceramic surface according to Example 5.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material.

“Anti-glare,” “antiglare,” “AG,” or like terms refer to a physical transformation of light contacting the treated surface of an article, such as a display, of the disclosure that changes, or to the property of changing light reflected from the surface of an article, into a diffuse reflection rather than a specular reflection. In embodiments, the surface treatment can be produced by mechanical, chemical, electrical, and like etching methods, or combinations thereof. Anti-glare does not reduce the amount of light reflected from the surface, but only changes the characteristics of the reflected light. An image reflected by an anti-glare surface has no sharp boundaries. In contrast to an anti-glare surface, an anti-reflective surface is typically a thin-film coating that reduces the reflection of light from a surface via the use of refractive-index variation and, in some instances, destructive interference techniques.

“Haze” (also referred to as “transmission haze”) is a surface light scatter characteristic and refers to the percentage of light scattered outside an angular cone of 4.0° in accordance with ASTM procedure D1003. For an optically smooth surface, transmission haze is generally close to zero. Low haze can be desirable for applications requiring high display contrast, while high haze can be useful for optical designs having scattering, such as edge illumination, or for aesthetic reasons, such as reducing the “black hole” appearance of the display in the off state. The general preference for low versus high haze (and the acceptance of performance trade-offs) can be motivated by customer or end-user preferences, and their final application and use mode.

“Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angle. The values obtained from these measurements are combined to provide a DOI value. In particular, DOI is calculated according to equation (1):

$$DOI = [ 1 - \frac{{R}_{OS}}{{R}_{S}} ] \times 100 \qquad ( 1 )$$

where Rs is the relative amplitude of reflectance in the specular direction and Ros is the relative amplitude of reflectance in an off-specular direction. As described herein, Ros, unless otherwise specified, is calculated by averaging the reflectance over an angular range from 0.2° to 0.4° away from the specular direction. Rs can be calculated by averaging the reflectance over an angular range of +0.05° centered on the specular direction. Both Rs and Ros were measured using a goniophotometer (Rhopoint Instruments) that is calibrated to a certified black glass standard, as specified in ASTM procedures D523 and D5767. The goniophotometer uses a detector array in which the specular angle is centered about the highest value in the detector array. DOI was also evaluated using 1-side (black absorber coupled to rear of glass) and 2-side (reflections allowed from both glass surfaces, nothing coupled to glass) methods. The 1-side measurement allows the gloss, reflectance, and DOI to be determined for a single surface (e.g., a single roughened surface) of the glass article, whereas the 2-side measurement enables gloss, reflectance, and DOI to be determined for the glass article as a whole. The Ros/Rs ratio can be calculated from the average values obtained for Rs and Ros as described above. “20° DOI,” or “DOI 200” refers to DOI measurements in which the light is incident on the sample at 20° off the normal to the glass surface, as described in ASTM D5767. The measurement of either DOI or common gloss using the 2-side method can best be performed in a dark room or enclosure so that the measured value of these properties is zero when the sample is absent.

For anti-glare surfaces, it is generally desirable that DOI be relatively low and the reflectance ratio (Ros/Rs) of eq. (1) be relatively high. This results in visual perception of a blurred or indistinct reflected image. In embodiments, the at least one roughened surface of the glass article has a Ros/Rs greater than about 0.1, greater than about 0.4, and, greater than about 0.8, when measured at an angle of 20° from the specular direction using the 1-side method measurement. Using the 2-side method, the Ros/Rs of the glass article at a 20° angle from the specular direction is greater than about 0.05. In embodiments, the Ros/Rs measured by the 2-side method for the glass article is greater than about 0.2, and greater than about 0.4. Common gloss, as measured by ASTM D523, is insufficient to distinguish surfaces with a strong specular reflection component (distinct reflected image) from those with a weak specular component (blurred reflected image). This can be attributable to the small-angle scattering effects that are not measurable using common gloss meters designed according to ASTM D523. The scale value obtained with the measuring procedures of ASTM D5767 range from 0 to 100 with a value of 100 representing perfect DOI (image clarity).

“Roughness,” “surface roughness (Ra),” or like terms refer to, on a microscopic level or below, an uneven or irregular surface condition, such as an average root mean squared (RMS) roughness or RMS roughness described below.

“Gloss,” “gloss level,” or like terms refer to, for example, surface luster, brightness, or shine, and more particularly to the measurement of specular reflectance calibrated to a standard (such as, for example, a certified black glass standard) in accordance with ASTM procedure D523. Common gloss measurements are typically performed at incident light angles of 20°, 60°, and 85°, with the most commonly used gloss measurement being performed at 60°. Due to the wide acceptance angle of this measurement, however, common gloss often cannot distinguish between surfaces having high and low distinctness-of-reflected-image (DOI) values.

“ALF” or “average characteristic largest feature size” or like terms refer to a measure of surface feature variation in the x- and y-directions, i.e., in the plane of the substrate, as discussed further below.

As used herein, the term “flexural strength” refers to the flexural strength of a glass article determined using a modified ring on ring test method (modified ROR test) similar to the test method described in ASTM C1499-03 “Standard Test Method for Monotonic Equibiaxial Flexural Strength of Advanced Ceramics at Ambient Temperature.” The modified ROR test is conducted using slightly different test fixtures and test conditions than those described in ASTM C1499-03. Specifically, a 50 mm×50 mm sample is tested using a 1 inch diameter support ring and a ½ inch diameter loading ring. The radius of curvature of the rings is 1/16 inch. The load is applied at a rate of 1.2 mm/min. The test is performed at room temperature in 50% relative humidity. The general conditions for the modified ROR test are outlined in U.S. Patent Application Pub. No. 2013/0045375 (e.g., at paragraph 0027), which is incorporated by reference herein in its entirety.

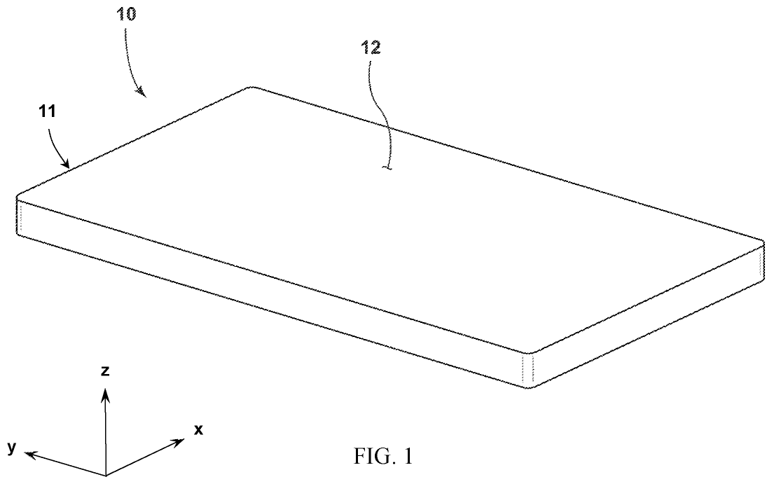

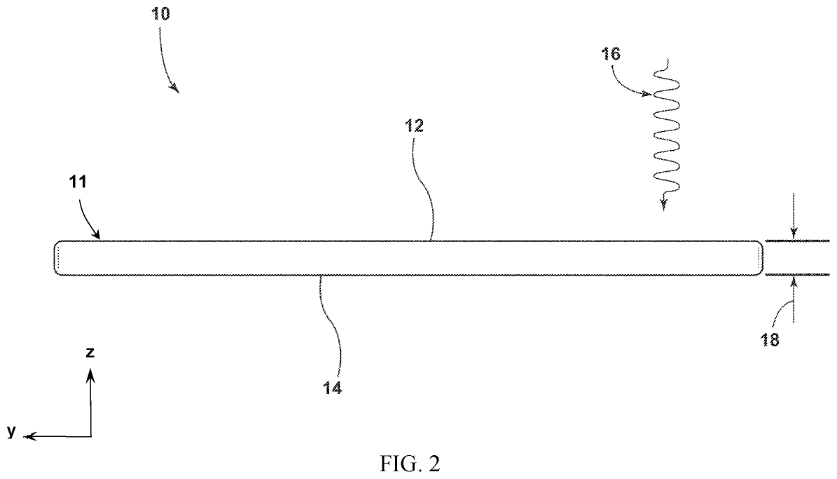

Referring now to FIGS. 1 and 2, an article 10 is illustrated. The article 10 includes a substrate 11 that comprises a glass, glass-ceramic, or ceramic composition. The substrate 11 has a first surface 12 and a second surface 14 that is opposite the first surface 12. The first surface 12 and the second surface 14 can be the primary or major surfaces of the substrate 11 through which incident electromagnetic radiation in a visible spectrum 16 thereof (hereinafter referred to as “visible light 16”) transmits and/or reflects. The first surface 12 and the second surface 14 are typically generally planar and parallel, as in the illustrated embodiment, but can be curved and/or not parallel. The substrate 11 can be a sheet that has a thickness 18 defined as a straight-line distance, normal to either the first surface 12 or second surface 14 or both, between the first surface 12 and the second surface 14. The substrate 11 in embodiments can have other shapes such as a three-dimensional shape.

The substrate 11 can have any composition that is suitable for the desired article 10 of which the substrate 11 is a component. In embodiments, the substrate 11 can be formed from a glass composition that includes borosilicate glass, aluminosilicate glass, soda-lime glass, alkali aluminosilicate glass, or alkali aluminoborosilicate glass, although other categories of substrates are contemplated, such as those including alkaline earth oxides.

In embodiments, the substrate 11 can be formed from a glass-ceramic material having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite. “Glass-ceramics” include materials produced through controlled crystallization of glass. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spodumene, cordierite, and lithium disilicate. In an exemplary embodiment, the substrate 11 includes any one of the glass-ceramic compositions disclosed in U.S. Patent Application Publication No 2016/0102010 A1, filed on Oct. 8, 2015, which is incorporated by reference in its entirety. The glass-ceramic substrates may be strengthened using a chemical strengthening process.

In some embodiments, the substrate 11 includes a ceramic material such as inorganic crystalline oxides, nitrides, carbides, oxy nitrides, carbo nitrides, and/or the like. Illustrative ceramics include those materials having an alumina, aluminum titanate, mullite, cordierite, zircon, spinel, perovskite, zirconia, ceria, silicon carbide, silicon nitride, silicon aluminum oxynitride, or zeolite phase.

In embodiments, the substrate 11 can be transparent to at least one wavelength in a range from about 390 nm to about 700 nm. In embodiments, the substrate 11 can transmit at least 70%, at least 75%, at least 80%, at least 85%, or at least 90% of at least one wavelength in a range from about 390 nm to about 700 nm. In embodiments, substrate 11 can be a nontransparent material.

Referring now to FIGS. 3-7, at least one of the major surfaces 12, 14 of the substrate 11, such as the first surface 12, has a roughened or textured region 19 that includes, for example, a plurality of surface features 20, such as, projections, protrusions, depressions, pits, islands, lands, trenches, fissures, crevices, and like geometries and features, or combinations thereof. In embodiments, the textured region 19 can cover an area less than the area of the major surface 12, 14 on which it is disposed or an area equal to the area of that major surface 12, 14. In embodiments, the surface features 20 are defined by the first surface 12.

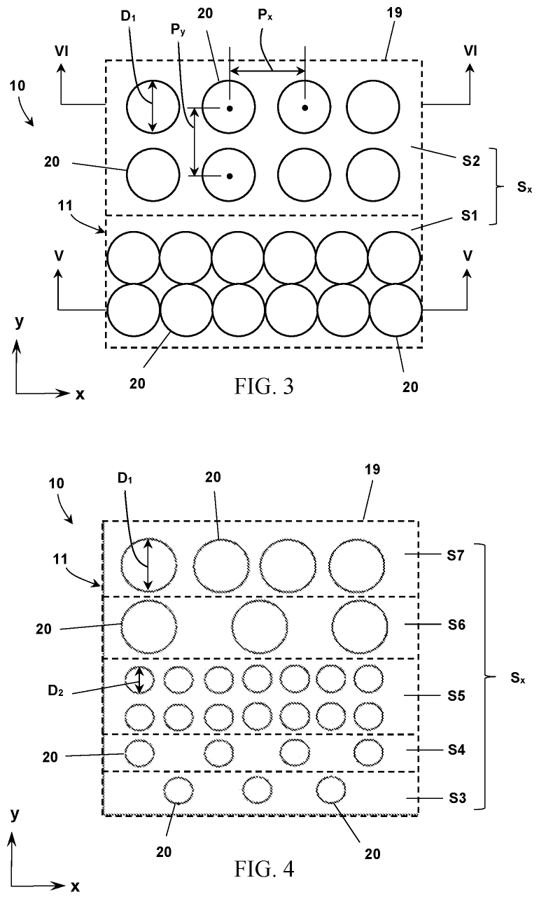

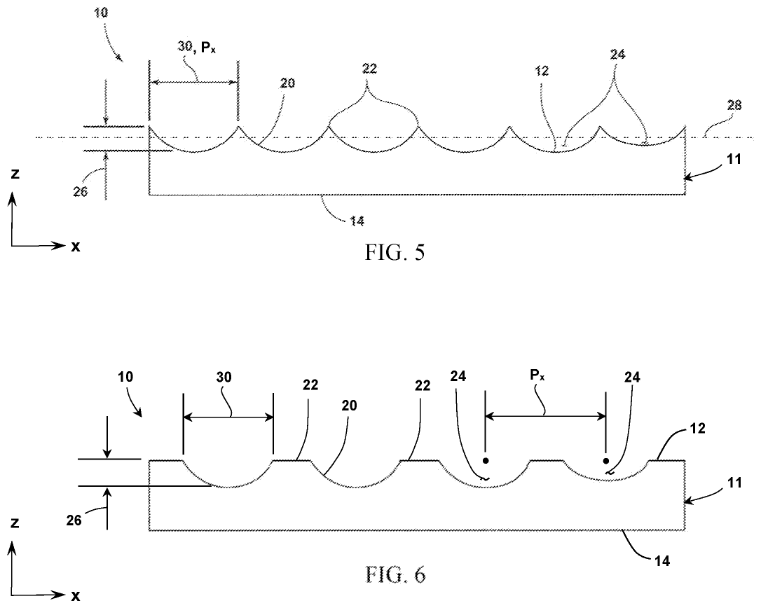

FIGS. 3 and 4 are conceptual top views of the textured region 19 to illustrate the surface features 20 in different configurations, which are described later in this disclosure. FIG. 5 is a conceptual cross-sectional view taken through line V-V of FIG. 3 to illustrate a topography of the surface features 20 within a first subregion S1 of the textured region 19. FIG. 6 is a conceptual cross-sectional view taken through line VI-VI of FIG. 3 to illustrate a topography of the surface features 20 within a second subregion S2 of the textured region 19.

Since the surface features 20 are generally approximately partial spherical or ellipsoid voids, in the illustrated embodiment, the surface features 20, when viewed at the cross-sections of FIGS. 5 and 6, provide peaks 22 and valleys 24. The distance between one of the peaks 22 and one of the valleys 24 of the surface feature 20 is a height or depth 26 of the surface feature 20. The height 26 of a surface feature 20 can be measured. The arithmetic average of the absolute values of the height deviations from a mean line 28, taken along a profile (line) (such as line V-V or line VI-VI), is referred to as the “average surface roughness” and is symbolized as “Ra.” Because Ra is determined based on deviation from the mean line 28 between the peaks 22 and the valleys 24 of all the surface features 20 along the line, the Ra is approximately half of the average peak to valley heights 26 of all the surface features 20 along the line. Various types of optical profilers can determine average surface roughness Ra for the first surface 12 of the substrate 11. A continuous surface area of the surface features 20 forms a “textured” first surface 12. It should be understood that the second surface 14 can be textured with surface features 20 as well.

Like the height 26 of a surface feature 20, an average width 30 of the surface features 20 can be measured. With the type of morphology of the embodiment illustrated in FIGS. 3-6, the width 30 of any particular surface feature 20 is the distance between one peak 22 and the adjacent peak 22 at the surface (which approximates a diameter D1, D2 of the surface feature 20). In some instances, the width 30 of any particular surface feature 20 can be the distance between one valley 24 and the next adjacent valley 24. Since the width 30 of a surface feature 20 is measured in the plane of the major surface 12, 14 on which it is disposed, the width 30 is independent of the height 26 of the surface feature 20 (and thus the width 30 is independent of the average surface roughness, Ra).

A standard calibrated optical light microscope or AFM can typically be used to measure the width 30 of a surface feature 20. Various methods of measuring the width 30 of the surface feature 20 can be utilized. The method of average characteristic largest feature size (abbreviated “ALF”) is the average x-y linear dimension of the twenty largest repeating surface features 20 within a viewing field on a first surface 12 that has been textured. The viewing field is proportional to the surface feature 20 size, and typically has an area of approximately 30 (ALF)×30 (ALF). If, for example, the ALF is approximately 10 μm, then the viewing field from which the twenty largest surface features 20 are selected is approximately 300 μm×300 μm. The standard deviation of the twenty largest surface features 20 that are used to determine ALF should generally be less than about 40% of the average value, i.e., major outliers should be ignored since these are not considered “characteristic” features. When the textured first surface 12 has the appearance conceptually shown, the surface features 20 to be measured in the ALF determination are the largest of the cells (circular-like peaks 22).

The ALF method is preferred over other methods that determine a more global average feature size, because the human eye most easily sees the largest surface features 20 and are therefore most important in determining visual acceptance of the substrate 11. However, one of those other methods that determine a more global average surface feature 20 size can be utilized to determine the average width 30 of the surface features 20. The ratio of height-to-width to the surface features 20 can thus be calculated as 2 Ra/ALF.

The distance between the centers of adjacent surface features 20 in at least one direction on the first surface 12 is a center to center pitch Pₓ, P_{y} of the surface features 20. The center of a given surface feature 20 can correspond to the centroid of a periphery of the given surface feature at the intersection of the surface feature 20 and the first surface 12. When the surface features 20 are generally approximately partial spherical or ellipsoid voids, as in the illustrated embodiment, the centroid of the surface feature 20 corresponds to the center point of the partial sphere or partial ellipse projected to a plane that is coplanar with the first surface 12. The center to center pitch Pₓ is the distance between the centroids or center points of adjacent surface features in the y-direction. The center to center pitch P_{y} is the distance between the centroids or center points of adjacent surface features 20 in the y-direction.

Referring again to FIGS. 3-6, the surface features 20 can have different configurations on the first surface 12. A feature size and a feature position of each surface feature 20 can be selectively controlled such that the surface features 20 within at least one subregion Sₓ of the textured region have a distribution of feature sizes and/or feature positions in at least one direction (i.e., the x-direction or the y-direction of the coordinate axes depicted in FIGS. 3-6). In embodiments, the feature size corresponds to at least one of the width 30 of the surface feature 20 at the first surface 12 and the depth 26 of the surface feature 20 from the first surface 12. The feature position corresponds to the centroid or the center point of the surface feature 20 at the first surface 12 depending on the geometry of the periphery as discussed above.

In embodiments, the surface features 20 within the at least one subregion Sₓ can have the distribution of feature sizes, and the feature sizes within the at least one subregion Sₓ can be uniform. For example, the surface features 20 within each of the first subregion S1 and the second subregion S2 can have a width 30 (or a diameter D₁) that is the same for all the surface features 20 such that the feature size of width is uniform within the corresponding subregion S1, S2. Similarly, the surface features 20 within each of the first subregion S1 and the second subregion S2 can have a depth 26 that is the same for all the surface features such that the feature size of depth is uniform within the corresponding subregion S1, S2.

In embodiments in which the feature sizes within the at least one subregion Sₓ are uniform, the surface features 20 can have a standard deviation of feature size that is about 50% or less to the average feature size of all surface features 20 within the at least one subregion Sₓ. In embodiments, the standard deviation of feature size can be about 20% or less to the average feature size of all surface features 20 within the at least one subregion Sₓ.

In embodiments in which the feature sizes within the at least one subregion Sₓ are uniform, the width 30 of each surface feature 20 can be a value in a range of from about 5 μm to about 100 μm, from about 5 μm to about 90 μm, from about 5 μm to about 80 μm, from about 5 μm to about 70 μm, from about 5 μm to about 60 μm, from about 5 μm to about 50 μm, from about 5 μm to about 40 μm, from about 5 μm to about 30 μm, from about 5 μm to about 20 μm, from about 10 μm to about 100 μm, from about 20 μm to about 100 μm from about 30 μm to about 100 μm, from about 40 μm to about 100 μm, from about 50 μm to about 100 μm, from about 60 μm to about 100 μm, from about 70 μm to about 100 μm, from about 80 μm to about 100 μm, from about 10 μm to 90 μm, from about 20 μm to about 80 μm, from about 30 μm to about 70 μm, from about 40 μm to about 60 μm, or even from about 45 μm to about 55 μm.

In embodiments in which the feature sizes within the at least one subregion Sₓ are uniform, the depth 26 of each surface feature 20 can be a value in a range of from about 10 nm to about 100 μm, from about 10 nm to about 90 μm, from about 10 nm to about 80 μm, from about 10 nm to about 75 μm, from about 10 nm to about 50 μm, from about 10 nm to about 25 μm, from about 10 nm to about 10 μm, from about 10 nm to about 1 μm, from about 25 nm to about 100 μm, from about 50 nm to about 100 μm, from about 75 nm to about 100 μm, from about 100 nm to about 100 μm, from about 200 nm to about 100 μm, from about 500 nm to about 100 μm, from about 750 nm to about 100 μm, from 0.1 μm to about 100 μm, from about 25 nm to about 90 μm, from about 50 nm to about 80 μm, from about 75 nm to about 75 μm, from about 100 nm to about 50 μm, from about 200 nm to about 25 μm, from about 500 nm to about 10 μm, from about 750 nm to about 1 μm, or even from about 0.1 μm to about 1 μm.

In embodiments, a ratio of the width 30 to the depth 26 of each surface feature 20 (i.e., an aspect ratio) is about 5 or greater, about 7.5 or greater, about 10 or greater, or even about 15 or greater. The aspect ratio can be less than about 5 in embodiments, for example, 4 or less, 3 or less, or even 2 or less.

In embodiments, the surface features 20 within the at least one subregion Sₓ can have the distribution of feature sizes and the feature sizes within the at least one subregion Sₓ can vary with respect to one or more of the width 30 and the depth 26. For example, the width 30 of some of the surface features 20 within the at least one subregion Sₓ can be different than the width 30 of others of the surface features 20 within the at least one subregion Sₓ. Similarly, the depth 26 of some of the surface features 20 within the at least one subregion Sₓ can be different than the depth 26 of others of the surface features 20 within the at least one subregion Sₓ.

In embodiments, the surface features 20 within the at least one subregion Sₓ can have the distribution of feature positions, and the feature positions within the at least one subregion Sₓ can be arranged in a pattern. For example, the surface features 20 in the first subregion S1 have the same center to center pitch in the x-direction Pₓ and the same center to center pitch in the y-direction. Similarly, the surface features 20 in the second subregion S2 have the same center to center pitch in the x-direction Pₓ and the same center to center pitch in the y-direction. As illustrated in FIGS. 3, 5, and 6, the center to center pitches Pₓ, P_{y} of the surface features 20 within the first subregion S1 are smaller than the center to center pitches Pₓ, P_{y} of the surface features 20 within the second subregion S2.

The center to center pitch Pₓ, P_{y} between adjacent surface features 20 and the respective widths 30 of the adjacent surface features 20 determine whether the adjacent surface features 20 are continuous or discrete. A surface feature 20 is discrete when its entire periphery at the first surface 12 is spaced apart from the peripheries of all adjacent surface features 20 at the first surface 12 by at least 5 nm, at least 25 nm, at least 100 nm, at least 500 nm, or even at least 0.1 μm. To say another way, a surface feature 20 is discrete when its entire periphery at the first surface 12 does not contact any portion of the peripheries of all adjacent surface features 20 at the first surface 12. Conversely, a surface features 20 is continuous when its periphery at the first surface 12 contacts any portion of a periphery of an adjacent surface feature 20 at the first surface. As shown in FIGS. 3 and 5, the surface features 20 of the first subregion S1 are continuous via contact in both the x-direction and the y-direction. As shown in FIGS. 3 and 6, the surface features of the second subregion S2 are discrete since there is no contact between adjacent surface features 20.

In embodiments, the surface features 20 within the first subregion S1 can have a first distribution of feature sizes and/or feature positions and the surface features 20 with the second subregion S2 can have a second distribution of feature sizes and/or feature positions that is different than the first distribution of feature sizes and/or feature positions. For example, with regard to feature position, the center to center pitches Pₓ, P_{y} of the surface features 20 within the first subregion S1 are different (i.e., smaller) than the center to center pitches Pₓ, P_{y} of the surface features 20 within the second subregion S2. With regard to the feature size corresponding to the depth 26, the depths 26 of the surface features 20 within the first subregion S1 can be different (one of smaller or larger) than the depths 26 of the surface features 20 within the second subregion S2. With regard to the feature size corresponding to the width 30, the widths 30 of the surface features 20 within the first subregion S1 can be different (one of smaller or larger) than the widths 30 of the surface features 20 within the second subregion S2.

The textured region 19 can include any number of subregion Sₓ. As shown in FIG. 4, for example, the textured region 19 includes five subregions with surface features in each of a third subregion S3, a fourth subregion S4, a fifth subregion S5, a sixth subregion S6, and a seventh subregion S7. The surface features 20 within each of the subregions S3-S7 of FIG. 4 have corresponding third, fourth, fifth, sixth, and seventh distributions of features sizes and/or features positions that differ with respect to one another. The differences in the respective distributions of the surface features 20 can relate to the number of surface features 20 within each subregion as well as the width, depth, and pitch of the surface features 20.

The substrate 11 has various measurable attributes within the textured region 19. The attributes can relate to optical parameters such as haze, transmittance, gloss (20°, 60°, and) 85°, and distinctness-of-image (DOI). The attributes can also relate to surface morphology such as average surface roughness and root mean square surface roughness. In embodiments, the attribute of the substrate 11 within the textured region 19 has a first value within the first subregion S1 and a second value, different from the first value, within the second subregion S2. This difference between the first and second values of the attribute can be due to the difference between the first distribution of features sizes and/or feature positions and the second distribution of feature sizes and/or feature positions. To say another way, the different configurations of the surface features 20 within the various subregions Sₓ enable same surface (i.e., the first surface 12) to have different and/or contrasting levels or values of the attribute.

In embodiments in which the attribute is haze, the textured region 19 can be configured such that a first planar position of the first surface 12 within the first subregion S1 differs from a second planar position of the first surface 12 within the second subregion S2, in a direction normal to the first surface (i.e., a direction parallel to the thickness 18 of the substrate 11), by 2 μm or less, by 1 μm or less, or even by 0.5 μm or less. The first planar position can be established by generating a first best-fit reference plane based on a plurality of the highest points across the first surface 12 within the first subregion S1. Similarly, the second planar position can be established by generating a second best-fit reference plane based on a plurality of the highest points across the first surface 12 within the second subregion S2. The relative difference between the first and second best-fit reference planes corresponds to the height difference of the first surface 12 at the first subregion S1 and at the second subregion S2.

In embodiments, the first surface 12 of the substrate 11 within the textured region 19 is substantially free of subsurface cracks. As used herein, “substantially free” means that less than 5%, less than 4%, less than 3%, less than 2%, less than 1%, or even less than 0.5% of a total area of the textured region 19 contains subsurface cracks subsequent to laser and chemical etch processes used to generate the surface features 20. Subsurface cracking is an issue with some forms of laser texturing. Such subsurface cracks may degrade the cosmetic appearance of a substrate surface and may compromise mechanical performance. Without being bound by theory, it is believed that subsurface cracking is caused by the thermal stress generated from the laser radiation on the surface of the substrate.

In embodiments, a material of the substrate 11 proximate to the first surface 12 within the surface features 20 can be different than a bulk material of the substrate 11 spaced from the surface features 20. The material can be different than the bulk material with respect to one or more of chemical composition and phase. For example, subsequent to the laser processes used to generate the surface features 20, a portion of the substrate 11 proximate to the first surface 12 and within the surface features 20 can have composition- and/or phase-related changes. Regarding phase-related changes, at least 0.5 μm, at least 1 μm, at least 2 μm, or even at least 3 μm of the substrate 11 proximate to the first surface 12 within the surface features 20 can undergo a conversion from a crystal phase to a glassy phase.

In embodiments, the substrate 11 is chemically strengthened via diffusion processes through the first surface 12 and the second surface 14. The substrate 11 is preferably chemically strengthened after forming the surface features 20 via laser texturing and wet etching processes as described later in this disclosure. The chemical strengthening process may induce warp in the substrate. Warp may be problematic when it exceeds a designated tolerance, rendering the substrate unsuitable for its intended purposed. The warp is measured as the total instrument readout or total indicator reading (TIR), the difference between the maximum and minimum height, across a major surface of the substrate along a diagonal as reported by a Flat Master 200 commercially available device. The diagonal as utilized for the warp measurement is the diagonal between two corners for rectangular parts. For non-rectangular parts, the diagonal refers to the longest possible distance along the major surface of the part. In embodiments, the TIR of the second surface 14 is less than about 20 μm, less than about 18 μm, less than about 15 μm, less than about 12 μm, or even less than about 10 μm.

The warp may be related to the diagonal measurement of the substrate. For example, a higher amount of warp may be acceptable for substrates with larger diagonal measurements. In embodiments, a substrate 11 with a diagonal of about 70.1 mm, based on a substrate surface measuring about 50 mm (length)×50 mm (width) and a substrate thickness of about 0.6 mm, has a TIR of less than about 20 μm. For substrates with surfaces that are larger than 50 mm×50 mm (e.g., with a larger diagonal), the surface to be measured can be divided into the smallest number of 50 mm×50 mm surface portions sufficient to cover an entirety of the surface to be measured, and then the TIR of each surface portion is measured to verify TIR is less than about 20 μm. For substrates with surfaces that are smaller than 50 mm×50 mm (e.g., with a smaller diagonal), the TIR along the longest possible distance along the major surface of the substrate should be less than about 20 μm.

In embodiments, the article 10 comprises a flexural strength of at least 1.75 GPa based on ring on ring (RoR) testing. The flexural strength in embodiments can be at least 2 GPa, at least 2.25 GPa, at least 2.5 GPa, at least 2.75 GPa, or even at least 3 GPa based on RoR testing. The flexural strength is preferably measured after forming the surface features 20 via laser texturing and wet etching processes and after chemically strengthening as described later in this disclosure.

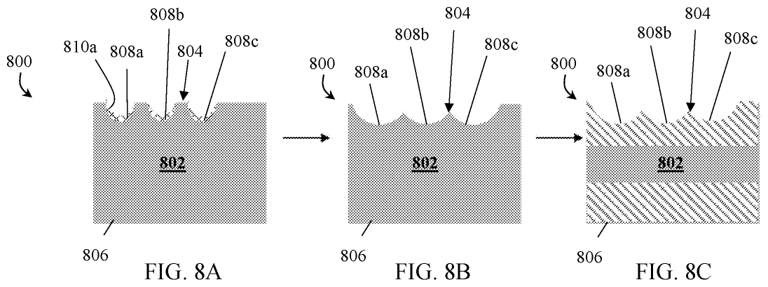

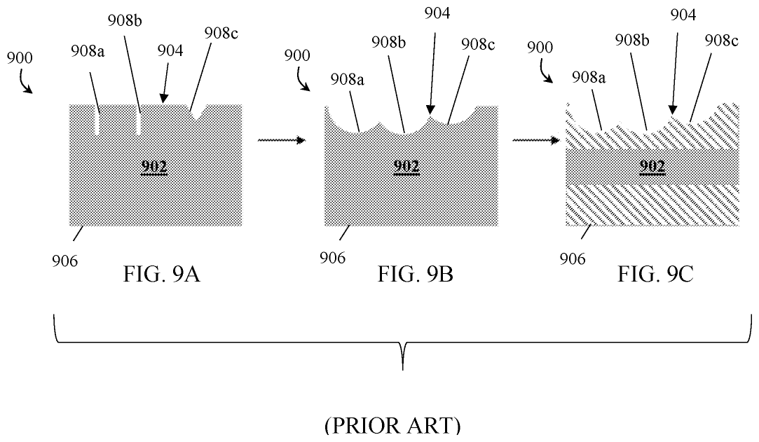

Referring now to FIGS. 8A-8C, a method of texturing an article 800 according to the principles of the present disclosure is illustrated. The article 800 includes a glass, glass ceramic, or ceramic substrate 802 with a first surface 804 and an opposite second surface 806 that are not textured. The method initially includes heating the substrate 802 to a target temperature. The target temperature in embodiments is at least 300° C., at least 325° C., at least 350° C., at least 375° C., at least 400° C., at least 450° C., at least 475° C., at least 500° C., or even at least 600° C.

Next, referring to FIG. 8A, the method includes directing pulsed radiation from a laser at the first surface 804 of the substrate 802 to form a plurality of surface features 808, such as first, second, and third surface features 808a, 808b, and 808c, respectively, within a textured region, such as the textured region 19 of FIGS. 3-6. The surface features 808 each have a feature size and a feature position, as described above with reference to FIGS. 3-6, controlled by the pulsed radiation. The method further includes configuring the laser to emit the pulsed radiation to form a first subregion of the surface features within the textured region, such as the surface features 20 within the first subregion S1 of FIGS. 3-6. The surface features within the first subregion have a first distribution of feature sizes and/or feature positions in at least one direction. The first predetermine distribution of feature sizes and/or feature positions can include any of the configurations described above with reference to FIGS. 3-6.

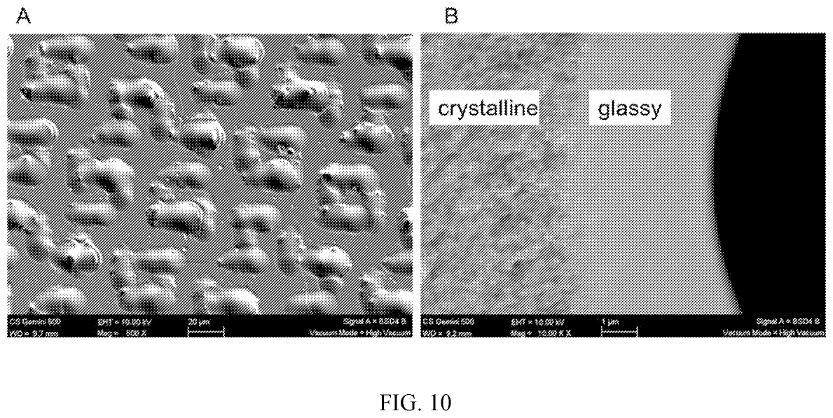

In embodiments, the pulsed radiation from the laser can cause a portion of the material of the substrate 802 proximate to the first surface 804 and within the surface features 808 to have composition- and/or phase-related changes, as conceptually illustrated by material portion 810a. For example, FIG. 10 is an image of a cross section through an individual surface feature, such as the surface feature 808a in FIG. 8, showing composition/phase changes at the surface. As shown in FIG. 10, approximately the first 3 μm of the ceramic surface has turned from crystal phases to glassy phase (amorphous) after laser texturing.

In embodiments, a material of the substrate 11 proximate to the first surface 12 within the surface features 20 can be different than a bulk material of the substrate 11 spaced from the surface features 20. The material can be different than the bulk material with respect to one or more of chemical composition and phase. For example, subsequent to the laser processes used to generate the surface features 20, a portion of the substrate 11 proximate to the first surface 12 and within the surface features 20 can have composition- and/or phase-related changes. Regarding phase-related changes, at least 0.5 μm, at least 1 μm, at least 2 μm, or even at least 3 μm of the substrate 11 proximate to the first surface 12 within the surface features 20 can undergo a conversion from a crystal phase to a glassy phase.

In embodiments, configuring the laser to emit the pulsed radiation to form the first subregion of surface features comprises setting one or more parameters of the laser. The parameters can include a laser type, a center wavelength, a repetition rate, an average power, a pulse duration, a pulse energy, a beam shape, a focal length, a spot size, a scanning method, a scanning speed, a scanning pitch spacing, a scanning line spacing, a laser fluence, as well as other parameters. Details of the one or more parameters, including the settings thereof, are described in the Examples section of this disclosure.

Next, referring to FIG. 8B, the method includes wet etching the substrate 802 by exposing the first surface 804 and the second surface 806 to an etchant. The etchant in embodiments can include hydrofluoric acid (HF). The etchant in embodiments can include an aqueous hydroxide material such as NaOH, KOH, or combination thereof. The wet etching is configured to remove material from the first surface 804 and the second surface 806 of the substrate 802. In embodiments, the wet etching removes at most 20 μm, at most 15 μm, at most 10 μm, at most 5 μm, at most 2 μm, at most 1 μm from each of the first surface 804 and the second surface 806.

Next, referring to FIG. 8C, the method includes chemically strengthening the substrate 802 through the first surface 806 with the surface features 808 and the second surface 806. In chemical strengthening, larger alkali metal ions are exchanged for smaller mobile alkali ions near the surfaces 804, 806 of the substrate 802. This ion-exchange process places the surfaces 804, 806 of the substrate 802 in compression, allowing the substate 802 to be more resistant to any mechanical damage. In embodiments, the surfaces 804, 806 of the article can optionally be ion-exchanged where smaller metal ions are replaced or exchanged by larger metal ions having the same valence as the smaller ions. For example, sodium ions in the substrate can be replaced with larger potassium ions by immersing the glass in a molten alkali salt bath containing potassium ions at a predefined temperature. The replacement of smaller ions with larger ions creates a compressive stress within the layer. In embodiments, the larger ions near the surfaces 804, 806 of the substrate 802 can be replaced by smaller ions, for example, when heating the substrate to a predefined temperature. Upon cooling, a compressive stress is created in an outer surface layer of the substrate 802.

The method in embodiments further comprises configuring the laser to emit the pulsed radiation to form a second subregion of surface features within the textured region, such as the surface features 20 within the second subregion S2 of FIGS. 3-6. The surface features within the second subregion have a second distribution of feature sizes and/or feature positions in the at least one direction that is different than the first distribution of feature sizes and/or feature positions. The first predetermine distribution of feature sizes and/or feature positions and the second predetermine distribution of feature sizes and/or feature positions can include any of the configurations described above with reference to FIGS. 3-6. In embodiments, configuring the laser to emit the pulsed radiation to form the second subregion of surface features comprises changing at least one of the one or more parameters of the laser.

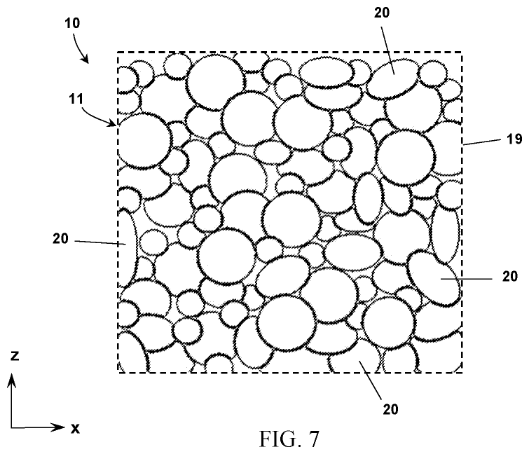

A method of texturing an article according to another embodiment is illustrated with reference to FIG. 7. The method includes heating a substrate that comprises a glass, glass-ceramic, or ceramic composition to a target temperature and directing pulsed radiation from a laser at a first surface of the substrate to form a plurality of surface features within a textured region similarly as included in the method described above with reference to FIGS. 8A-8C. The method illustrated with reference to FIG. 7 also includes configuring the laser to emit the pulsed radiation to form at least one subregion of surface features within the textured region similarly as included in the method described above with reference to FIGS. 8A-8C. However, in the method illustrated with reference to FIG. 7, the surface features within the at least one subregion have a continuous and random distribution of feature sizes and feature positions.

### Examples

The following examples further clarify the various embodiments disclosed herein.

### Example 1-Texturing Glass-Ceramic Surfaces via Ultrafast Laser

Surface features (micro-craters) were textured on glass ceramic substrates using an ultrafast laser system (Pharos, Light Conversion). Ultrafast laser systems have the unique characteristics of ultrafast short pulse width (10⁻¹²-10⁻¹⁵ s) and extremely high peak intensity (>10¹³ W/cm²). When used for high precision fabrication, ultrafast laser systems have many advantages, such as negligible cracks, minimum heat affected zones, low recast, and high precision, compared with long pulse (i.e., nanosecond (10⁻⁹ s)) lasers.

The central wavelength, pulse width, and repetition rate of the diode pumped solid state laser were set at 1030 nm, 300 fs, and 200 kHz, respectively. The maximum output power of the laser was 6 W. Different pulse energies were assessed, including 0.2 μJ/pulse, 0.6 μJ/pulse, 1 μJ/pulse, 2 μJ/pulse, 6 μJ/pulse, and 10 μJ/per pulse. The pulse energy used for fabrication was approximately 10 μJ per pulse. The laser beam was steered through a galvanometer scanner and focused on glass ceramic samples through a conventional F-theta lens with the focal length of 80 mm. The spot size was approximately 17 μm in air at the focal point. The glass ceramic samples were rapidly scanned via cross-hatching method with a pitch of 25 μm. The scanning speed of the scanner was set at 500 mm/s. Surface features were textured into the samples with various laser fluences by adjusting either the internal laser attenuators or the external laser beam optics, including a half-wave plate and a polarizer.

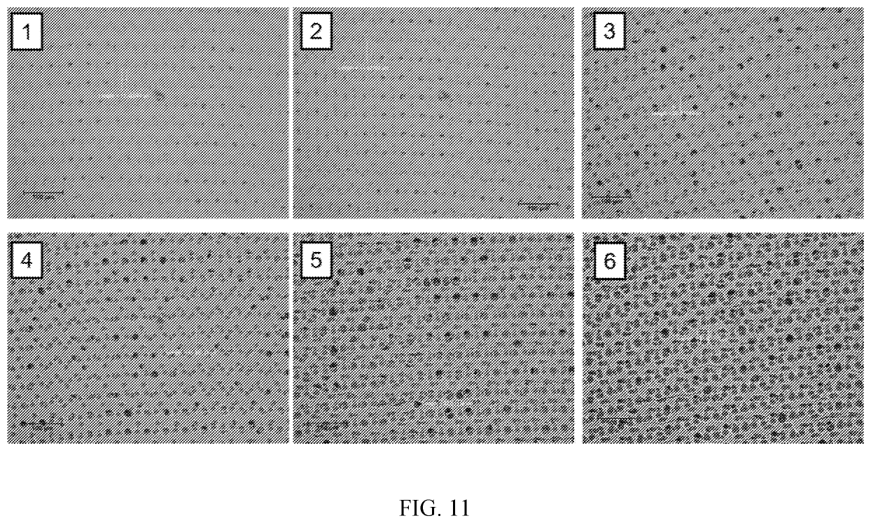

FIG. 11 are images of six sample surfaces that were laser textured in a common pattern with six different laser intensities: Condition 1:0.2 μJ/pulse; Condition 2:0.6 μJ/pulse; Condition 3:1 μJ/pulse; Condition 4:2 μJ/pulse; Condition 5:6 μJ/pulse, and Condition 6:10 μJ/per pulse, respectively.

The ultrafast laser used for glass ceramic surface texturing has various operating wavelengths (i.e., 532 nm, 800 nm, 1030 nm, etc.) and the pulse width of the laser can be varied from tens of fs to several ps (i.e., 10 ps). The spot size after focusing can be controlled by changing the focal length of the F-theta lens. Both fiber-based and solid-state lasers can be used for laser texturing. To improve throughput, the single gaussian beam can be shaped to multi-foci beams on the glass ceramic samples using special optics or a spatial light modulator (SLM) for parallel processing. A polygon scanner is another option.

### Example 2-Texturing Glass-Ceramic Surfaces via CO₂ Laser

Since glass and glass ceramics generally have strong absorption at mid- and far-infrared wavelengths, high power lasers, such as such as CO (5.6 μm) and CO₂ (9.3 μm, 10.6 μm, 11.2 μm), can be used to rapidly texture glass surfaces. There are several approaches to texture surfaces of glass ceramics.

In one approach, the mid- or far-infrared lasers are rapidly scanned over the glass surface. The non-overlapping or partially overlapped laser pulses, typically with a pulse length of some microseconds, generate many bumps on the surface of the glass ceramics. The bump height, depending on glass composition, can be of microns or tens of microns. The bumps can have a diameter of roughly 10˜20 μm.

In another approach, a significantly higher laser power density is used in scanning over surface of the glass ceramics. The much higher laser power density (higher than 100 kW/cm²) results in localized laser ablation. The ablated glass surface creates the texturing effect for glass ceramics. In one example, a nanosecond 9.3 μm CO₂ laser is used. This process creates glass surface with dimples with a diameter of around 20 μm.

In yet another approach, a combination of CO₂ laser ablation and chemical etching process is used to texture the glass surface. A CO₂ laser beam with a diameter of 700 μm is scanned rapidly across the glass surface. The non-overlapping CO₂ laser pulses ablate the glass surface. The residual stress generated by the ablation process results in localized spallation at the glass surface. After chemical etching, the glass fragments are removed, and a textured glass surface is obtained.

### Example 3-Wet Etching

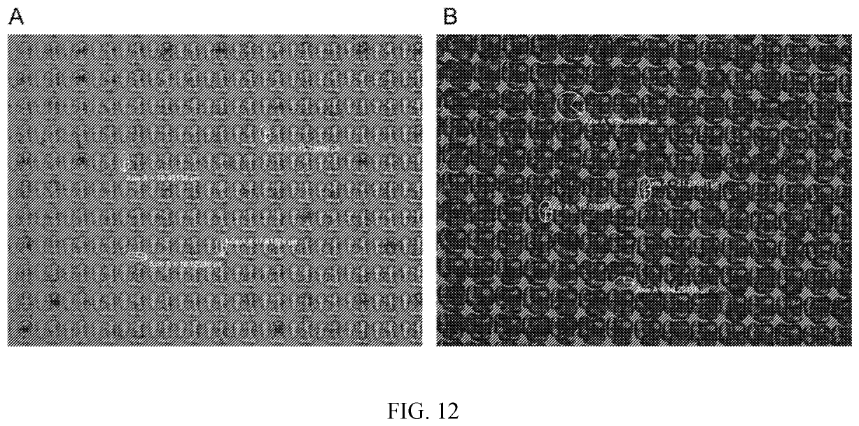

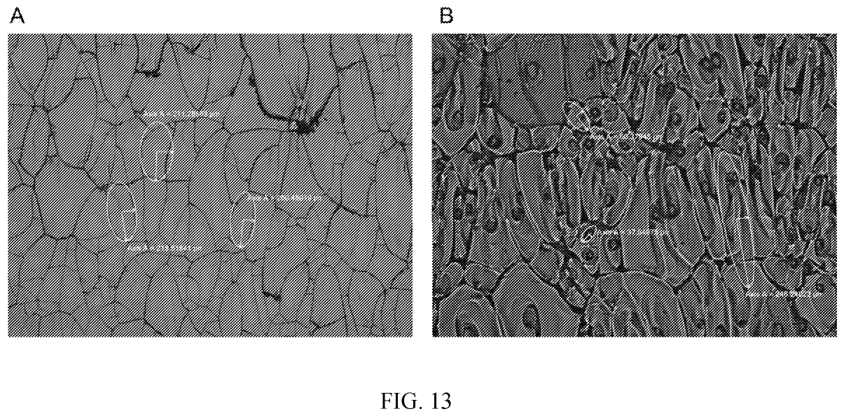

The laser textured samples from Examples 1 and 2 were etched in 50 wt % NaOH for 3 hr at 120° C. The etching further modified the glass surface. For example, FIG. 12 illustrates a glass ceramic surface textured with the ultrafast laser using 10 μJ/per pulse according to Example 1 prior to etching (left) and the same glass ceramic surface after etching (right). The ultrafast laser treated surface features grew larger after the 3 hr etching.

FIG. 13 illustrates a glass ceramic surface textured with the CO₂ laser. As shown, a continuous and random surface texture can be fabricated through laser texturing with the CO₂ laser. Specifically, FIG. 13 illustrates a glass ceramic surface textured with the CO₂ laser using a frequency of 4 kHz and a scanning speed of 3200 mm/s according to Example 2 prior to etching (left) and the same glass ceramic surface after etching (right). The CO₂ laser treated surface changed in morphology after the 3 hr etching.

Tables 1 and 2 identify the conditions used in Examples 1 and 2, respectively, as well as the surface characterizations of the corresponding laser textured and etched surfaces.

TABLE 1
Surface characterization of ultrafast laser textured
(Example 1) and etched (Example 3) surface

| | Laser Condition | Etch Condition | |
|---|---|---|---|
| | 300 fs (pulse width); | Temp. | etch time |
| Sample | 200 kHz (frequency) | (° C.) | (hrs) |
| 1-1 | 10 μJ/per pulse | n/a | 0 |
| 1-2 | 10 μJ/per pulse | 112.6 | 1 |
| 1-3 | 10 μJ/per pulse | 112.6 | 3 |
| 1-4 | 6 μJ/pulse | n/a | 0 |
| 1-5 | 6 μJ/pulse | 112.6 | 1 |
| 1-6 | 6 μJ/pulse | 112.6 | 3 |

| | Optical Parameters | | | | | | Surface Morphology | | |
|---|---|---|---|---|---|---|---|---|---|
| Sample | Haze | Trans | G (20) | G (60) | G (85) | DOI | Ra (nm) | Rq (nm) | Rsk |
| 1-1 | 68.1 | 85.7 | 10.2 | 21.3 | 58.2 | 97.2 | 493.9 | 804.6 | −4.11 |
| 1-2 | 83.6 | 85.1 | 12 | 17.8 | 31.9 | 97.7 | 2154.5 | 2487.9 | −1.639 |
| 1-3 | 92.9 | 86.7 | 6.6 | 8.7 | 16.8 | 95.9 | 3815.7 | 4558.2 | −1.847 |
| 1-4 | 44 | 86.8 | 40.4 | 50.6 | 71.4 | 99 | 364.9 | 597.4 | −1.614 |
| 1-5 | 57.3 | 85.9 | 42.8 | 44.1 | 61.8 | 99.1 | 1421.2 | 1831.1 | −1.689 |
| 1-6 | 63.3 | 69.9 | 25.7 | 29.2 | 39.6 | 98.3 | 2098 | 2888.5 | −2.785 |

TABLE 2
Surface characterization of CO₂ laser textured
(Example 2) and etched (Example 3) surface

| | | | | Etch Conditions | |
|---|---|---|---|---|---|
| | Laser Conditions | | | Temp. | Etch Time |
| Sample | Condition | Frequency | Speed | (° C.) | (hrs) |
| 2-1 | 1 | 4 KHz | 3200 mm/s | n/a | 0 |
| 2-2 | 2 | 4 KHz | 1600 mm/s | n/a | 0 |
| 2-3 | 3 | 2 KHz | 1600 mm/s | n/a | 0 |
| 2-4 | 4 | 2 KHz | 3200 mm/s | n/a | 0 |
| 2-5 | 5 | 2 KHz | 3200 mm/s | n/a | 0 |
| 2-6 | 1 | 4 KHz | 3200 mm/s | 114.8 | 1 |
| 2-7 | 2 | 4 KHz | 1600 mm/s | 114.8 | 1 |
| 2-8 | 3 | 2 KHz | 1600 mm/s | 114.8 | 1 |
| 2-9 | 4 | 2 KHz | 3200 mm/s | 114.8 | 1 |
| 2-10 | 5 | 2 KHz | 3200 mm/s | 114.8 | 1 |
| 2-11 | 1 | 4 KHz | 3200 mm/s | 114.2 | 3 |
| 2-12 | 2 | 4 KHz | 1600 mm/s | 114.2 | 3 |
| 2-13 | 3 | 2 KHz | 1600 mm/s | 114.2 | 3 |
| 2-14 | 4 | 2 KHz | 3200 mm/s | 114.2 | 3 |
| 2-15 | 5 | 2 KHz | 3200 mm/s | 114.2 | 3 |

| | Optical Parameters | | | | | | Surface Morphology | |
|---|---|---|---|---|---|---|---|---|
| Sample | Haze | Trans | Gloss 20 | Gloss 60 | Gloss 85 | DOI (%) | Ra (nm) | Rq (nm) |
| 2-1 | 9.02 | 85.3 | 69.2 | 83.1 | 67.8 | 60.8 | 246.7 | 342.8 |
| 2-2 | 11.2 | 85 | 44.4 | 64.3 | 53.6 | 42.7 | 291.7 | 393.7 |
| 2-3 | 14.5 | 85.1 | 48.8 | 71.2 | 68.2 | 25.5 | 344.1 | 435.1 |
| 2-4 | 9.8 | 86.2 | 71.8 | 87.4 | 68.4 | 77.2 | 258.2 | 373.1 |
| 2-5 | 6.29 | 87.5 | 98.5 | 106.2 | 82.6 | 86.6 | 223.6 | 293.5 |
| 2-6 | 48 | 88.1 | 8.8 | 25.5 | 22.7 | 4.7 | 1818.8 | 2458.3 |
| 2-7 | 50.9 | 88.5 | 8.1 | 24.2 | 27.2 | 4 | 1230.9 | 1710.3 |
| 2-8 | 44.7 | 88.4 | 7.1 | 19.1 | 42.8 | 6.7 | 1789 | 2331.8 |
| 2-9 | 41.9 | 87.3 | 18.1 | 30.2 | 29.9 | 81.2 | 2000.6 | 2590.7 |
| 2-10 | 32.4 | 86.7 | 39.1 | 51.3 | 48.4 | 75.8 | 1944 | 2878.1 |
| 2-11 | 51.8 | 89 | 5.3 | 20.2 | 10.6 | 3.1 | 1580.8 | 2044 |
| 2-12 | 51.5 | 89 | 9.6 | 33.4 | 32.5 | 1.1 | 1979.1 | 3134.6 |
| 2-13 | 49.7 | 87.6 | 18.1 | 40.8 | 46.3 | 7.2 | 1479.7 | 2150.9 |
| 2-14 | 48.9 | 89.1 | 13.6 | 27.8 | 25.9 | 81.5 | 2731.8 | 3653.5 |
| 2-15 | 43.7 | 89 | 24.3 | 36.6 | 31.7 | 83.9 | 1903.4 | 2377 |

### Example 4-Laser Texturing of Glass at Elevated Temperature

The change in flexural strength from laser texturing was assessed.

CO₂ laser conditions: Laser: 3 kHz, 0.3 W; Speed: 90 mm/s (target 30 μm spacing), line spacing 30 μm.

Samples for RoR test: Group 1:8 samples at 500° C.; Group 2:4 samples at 300° C. (3 annealed at 700, 1 annealed at 600 for 12 hrs); Group 3:6 samples at RT and annealed at 700° C.; and Group 4:7 samples, control (no laser).

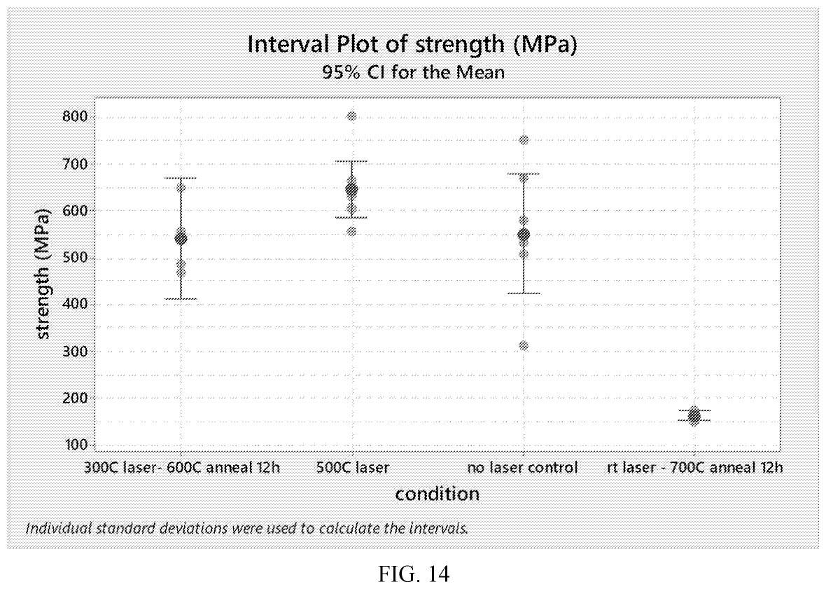

Flexural strength was assessed via RoR testing. The RoR data are listed in Table 3 and plotted in FIG. 14.

TABLE 3
RoR Study of Laser Texturing with Preheated Glass or with Post Anneal

| | Thickness | | | Peak Load | Strength | Strength | |
|---|---|---|---|---|---|---|---|
| Sample | (mm) | L | W | (kgf) | (psi) | (MPa) | Condition |
| 4-1 | 0.592 | 50 | 50 | 54.130 | 94134 | 649.030 | 500 C. laser |
| 4-2 | 0.594 | 50 | 50 | 46.627 | 80541 | 555.309 | 500 C. laser |
| 4-3 | 0.597 | 50 | 50 | 51.196 | 87547 | 603.615 | 500 C. laser |
| 4-4 | 0.595 | 50 | 50 | 51.318 | 88346 | 609.123 | 500 C. laser |
| 4-5 | 0.600 | 50 | 50 | 54.030 | 91471 | 630.673 | 500 C. laser |
| 4-6 | 0.595 | 50 | 50 | 55.994 | 96396 | 664.629 | 500 C. laser |
| 4-7 | 0.602 | 50 | 50 | 57.437 | 96593 | 665.984 | 500 C. laser |
| 4-8 | 0.600 | 50 | 50 | 68.827 | 116521 | 803.385 | 500 C. laser |
| 4-9 | 0.600 | 50 | 50 | 40.316 | 68253 | 470.590 | 300 C. laser- 600 C. anneal 12 h |
| 4-10 | 0.603 | 50 | 50 | 48.109 | 80639 | 555.985 | 300 C. laser- 600 C. anneal 12 h |
| 4-11 | 0.600 | 50 | 50 | 41.855 | 70858 | 488.552 | 300 C. laser- 600 C. anneal 12 h |
| 4-12 | 0.596 | 50 | 50 | 54.963 | 94303 | 650.198 | 300 C. laser- 600 C. anneal 12 h |
| 4-13 | 0.600 | 50 | 50 | 13.549 | 22938 | 158.153 | rt laser - 700 C. anneal 12 h |
| 4-14 | 0.607 | 50 | 50 | 13.092 | 21657 | 149.318 | rt laser - 700 C. anneal 12 h |
| 4-15 | 0.598 | 50 | 50 | 14.381 | 24509 | 168.983 | rt laser - 700 C. anneal 12 h |
| 4-16 | 0.606 | 50 | 50 | 15.094 | 25051 | 172.719 | rt laser - 700 C. anneal 12 h |
| 4-17 | 0.603 | 50 | 50 | 15.124 | 25350 | 174.780 | rt laser - 700 C. anneal 12 h |
| 4-18 | 0.593 | 50 | 50 | 13.105 | 22714 | 156.607 | rt laser - 700 C. anneal 12 h |
| 4-19 | 0.593 | 50 | 50 | 48.490 | 84041 | 579.443 | Control (no laser) |
| 4-20 | 0.590 | 50 | 50 | 55.597 | 97341 | 671.147 | Control (no laser) |
| 4-21 | 0.588 | 50 | 50 | 41.750 | 73596 | 507.426 | Control (no laser) |
| 4-22 | 0.588 | 50 | 50 | 43.791 | 77194 | 532.232 | Control (no laser) |
| 4-23 | 0.592 | 50 | 50 | 26.094 | 45378 | 312.874 | Control (no laser) |
| 4-24 | 0.593 | 50 | 50 | 62.941 | 109087 | 752.134 | Control (no laser) |
| 4-25 | 0.593 | 50 | 50 | 42.479 | 73623 | 507.617 | Control (no laser) |

The data show that heating glass article during laser treatment is effective in avoiding forming cracks on the laser treated surface.

Without heating the glass articles, cracks are caused by the thermal stress generated from CO₂ laser on glass. In addition, the single side treatment can cause glass warp because of unbalanced thermal stress on the treated and non-treated sides of the glass articles. Both the cracks and glass warp lower glass surface strength.

With preheating 0.6 mm glass-ceramic samples at 500° C., the laser treatment show no surface cracks. Laser treatment on 0.6 mm glass-ceramic samples at 300° C. followed by a 12 hr annealing at 600° C. shows good RoR strength as well. Both of these conditions show equivalent RoR strength compared to the non-textured control (0.6 mm glass-ceramic samples). On the other hand, laser treating 0.6 mm glass-ceramic samples at room temperature and 700° C. post-texturing annealing shows poor RoR strength.

These data suggest the heating treatment of glass during laser texturing is an effective approach to avoid surface crack formation and retain surface RoR strength. If large cracks are formed (for example, room temperature laser treatment), annealing does not help to recover the surface strength.

### Example 5-Laser Texturing of Glass at Elevated Temperature Followed by NaOH Etching and Ion Exchange

Experiment conditions/procedure: (1) Glass: 0.6 mm, glass-ceramic composition from U.S. Patent Application Publication No 2016/0102010 A1 (“GC” in Table 4); (2) Laser treatment on glass article at 500° C., (a) CO₂ Laser: 3 kHz, 0.3 W, (b) Speed: 90 mm/s (target 30 μm spacing), line spacing 30 μm; (3) The laser textured glass-ceramic samples are etched in 45% NaOH bath at 130° C. for 1 hr to remove 2 μm to 3 μm; (4) Ion Exchange (IOX): glass-ceramic samples are ion exchanged in 60 wt % KNO₃, 40 wt % NaNO₃, additional 0.12 wt % LiNO3, 0.5 wt % silicic acid at 500° C. for 6 hr; (5) glass-ceramic samples are then tested by RoR; (6) Glass flatness (warp), optical parameters, and surface roughness are measured before and after ion exchange for each group.

Groups: (1) non-textured glass-ceramic control: 0.6 mm glass-ceramic samples with ion exchange only; (2) Laser textured glass-ceramic samples at 500° C., then ion exchange; (3) Laser textured glass-ceramic samples at 500° C., then etched by NaOH, followed by ion exchange. The optical and surface characterization of the glass-ceramic samples from this experiment are reported in Table 4.

TABLE 4
Optical and Surface Characterization of Glass-Ceramic Samples from Example 5

| | | | Haze | Gloss | Gloss | Gloss | DOI |
|---|---|---|---|---|---|---|---|
| Sample | IOX | Transmittance | (%) | 20 (%) | 60 (%) | 85 (%) | (%) |
| GC Control | Before IOX | 93.5 | 0.16 | 149.5 | 145.9 | 113.7 | 99.4 |
| GC lasered only | Before IOX | 91.2 | 50 | 7 | 19.1 | 38.8 | 21.4 |
| GC lasered and etched | Before IOX | 91.8 | 49 | 9.2 | 25.6 | 53.4 | 6.7 |
| GC Control | Post IOX | 92.8 | 0.14 | 162.7 | 150.2 | 18.8 | 99.4 |
| GC lasered only | Post IOX | 90.9 | 55.7 | 6.4 | 18.7 | 45.5 | 20.6 |
| GC lasered and etched | Post IOX | 92 | 41.3 | 9.2 | 25.3 | 52.3 | 7.6 |

| | | | | | | Non texture | |
|---|---|---|---|---|---|---|---|
| | | | | | | side TIR | Delta TIR |
| Sample | IOX | Sal (um) | Ra (nm) | PV (nm) | Rsk | (um) | (um) |
| GC Control | Before IOX | 19.16 | 0.98 | 33.9 | −2.073 | 8.335 | |
| GC lasered only | Before IOX | 8.28 | 666.85 | 59842.3 | 0.494 | 43.306 | |
| GC lasered and etched | Before IOX | 13.63 | 824.77 | 56859.7 | 0.645 | 17.87 | |
| GC Control | Post IOX | 20.54 | 0.9 | 11.3 | −0.043 | 12.019 | 3.7 |
| GC lasered only | Post IOX | 8.88 | 612.66 | 58071.6 | −0.113 | 87.184 | 43.9 |
| GC lasered and etched | Post IOX | 14.36 | 901.03 | 55195.8 | 0.197 | 13.291 | −4.6 |

Glass for mobile electronic applications is usually chemically strengthened via ion exchange to improve the surface strength. The chemically strengthening process has monovalent metal ions exchange between glass and molten salt at and through glass-salt interface. The diffusivity is influenced by glass composition and surface treatment. Laser texturing on A side glass not only generates textures but can also create stress, cracking, and change of ion diffusivity. Heating glass during laser treatment can minimize the surface stress formation, avoid cracking generation, but may not enable equal diffusivity between laser treated and untreated sides. As such, the single-side laser treated glass can show an increase in warp. For example, Table 4 shows delta (TIR)=43.9 μm for a 50 mm×50 mm sample).

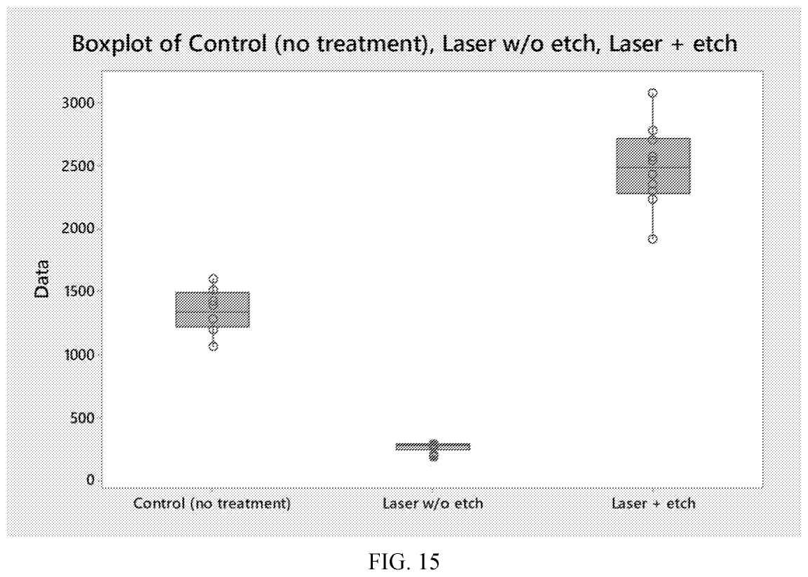

Since the CO₂ laser texturing only influences a shallow surface, a brief etching is applied to remove 2 μm on both sides of glass. The etching restores the diffusivity balance between the two sides of glass, the delta TIR of “laser+etch” sample is at the same level of non-treated GC control (−4.6 μm vs. 3.7 μm). The etching not only balances the diffusion of both sides of glass, but it also blunt the potential flaw on GC surface. Therefore, the “laser+etch” sample possesses RoR performances even higher than the control group, as illustrated in FIG. 15, which plots the RoR data of Example 5.

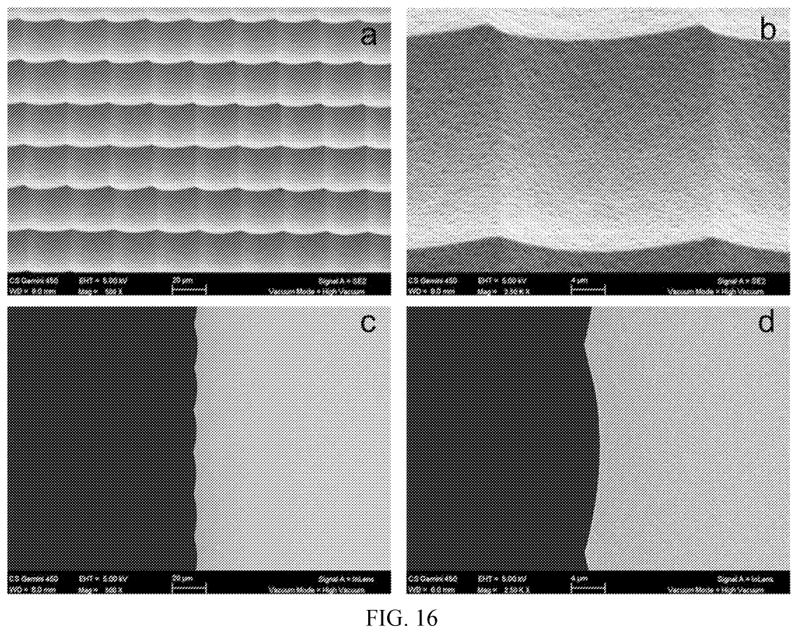

FIG. 16 are SEM images of CO₂ laser textured glass-ceramic surface according to Example 5. Viewing angle: a and b are at 58 degree tilting angle; c and d are cross-section view.

The processes and articles described herein provide numerous advantages.

The process advantages include the following. Compared to sandblast process, laser process can deliver energy more precisely both in energy level and in texture location. The precise and controlled texture can reduce the follow-up etching process time to improve overall texturing throughput. It may also improve the process yield since laser texture process does not create uncontrollable unexpected surface defects. Laser process can create different surface texture (haze) levels simultaneously without using any complicated masking process in sandblasting. Laser process can form controllable discrete surface features that neither wet etching nor sandblast and etching can deliver. Laser treatment on preheated glass article avoids the formation of subsurface cracks and reduces single side laser treatment introduced warp. Post laser treatment etching (removal of 1-2 μm) can restore the chemical balance between textured and non-textured sides. In consequence, the chemically strengthening process does not generate extra warp.

The article advantages include the following. Uniform/narrowly distributed surface features. Precise feature distance, controllable feature coverage area. Flat and sharp transition between texture and non-texture areas. Multiple surface feature levels (haze levels) on the same surface (without significant surface height difference). Flexible surface patterning (for example: texture surface with a glossy (non-texture) logo). Texture surface without any subsurface cracking. Textured and ion exchanged glass with minimum warp. Textured surface with good mechanical strength (e.g., Ring-On-Ring).

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. An article, comprising:
a glass, glass-ceramic, or ceramic substrate having a first surface; and
a textured region comprising a plurality of surface features defined by the first surface, a feature size and a feature position of each surface feature selectively controlled such that the surface features within at least one subregion of the textured region have a distribution of feature sizes and/or feature positions in at least one direction.

2. The article of claim 1, wherein the surface features within the at least one subregion have the distribution of feature sizes and the feature sizes within the at least one subregion are uniform.

3. The article of claim 2, wherein a standard deviation of feature size is about 50% or less to the average feature size of all surface features within the at least one subregion.

4. The article of claim 2, wherein a standard deviation of feature size is about 20% or less to the average feature size of all surface features within the at least one subregion.

5. The article of any one of claims 1-4, wherein the feature size is at least one of a width at the first surface and a depth from the first surface.

6. The article of claim 5, wherein the width is a value in a range of from about 5 μm to about 100 μm.

7. The article of claim 5, wherein the depth is a value in a range of from about 10 nm to about 10 μm.

8. The article of claim 5, wherein a ratio of width to depth is about 5 or greater.

9. The article of claim 1, wherein the surface features within the at least one subregion have the distribution of feature sizes, the feature sizes within the at least one subregion varying with respect to one or more of a width at the first surface and a depth from the first surface.

10. The article of any one of claims 1-9, wherein the surface features within the at least one subregion have the distribution of feature positions and the feature positions within the at least one subregion are arranged in a pattern.

11. The article of claim 10, wherein the surface features within the at least one subregion are discrete.

12. The article of claim 10, wherein the surface features within the at least one subregion are continuous.

13. The article of any one of claims 1-12, wherein:
the at least one subregion comprises a first subregion and a second subregion,
the surface features within the first subregion have a first distribution of feature sizes and/or feature positions, and
the surface features with the second subregion have a second distribution of feature sizes and/or feature positions that is different than the first distribution of feature sizes and/or feature positions.

14. The article of claim 13, wherein an attribute of the substrate within the textured region has a first value within the first subregion and a second value, different from the first value, within the second subregion.

15. The article of claim 13, wherein the attribute is at least one of haze, transmittance, gloss, distinctness-of-image (DOI), average surface roughness, and root mean square surface roughness.

16. The article of claim 15, wherein a first planar position of the first surface within the first subregion differs from a second planar position of the first surface within the second subregion by 2 μm or less in a direction normal to the first surface when the attribute is haze.

17. The article of claim 15, wherein a first planar position of the first surface within the first subregion differs from a second planar position of the first surface within the second subregion by 1 μm or less in a direction normal to the first surface when the attribute is haze.

18. The article of any one of claims 1-17, wherein the textured region is substantially free of subsurface cracks.

19. The article of any one of claims 1-18, wherein a material of the substrate proximate to the first surface within the surface features is different than a bulk material spaced from the surface features.

20. The article of claim 19, wherein the material is different than the bulk material with respect to one or more of chemical composition and phase.

21. The article of any one of claims 1-20, wherein the glass, glass-ceramic, or ceramic substrate is chemically strengthened through the first surface and a second surface opposite the first surface, and wherein a total indicator reading (TIR) of the second surface is less than 20 μm for each 50 mm×50 mm surface portion of the smallest number of 50 mm×50 mm surface portions configured to encompass an entirety of the second surface.

22. The article of claim 21, wherein the article comprises a flexural strength of at least 1.75 GPa based on ring on ring (RoR) testing.

23. A method of texturing an article, comprising:
heating a substrate that comprises a glass, glass-ceramic, or ceramic composition to a target temperature;
directing pulsed radiation from a laser at a first surface of the substrate to form a plurality of surface features within a textured region, the surface features each having a feature size and a feature position defined by the pulsed radiation; and
configuring the laser to emit the pulsed radiation to form a first subregion of surface features within the textured region, the surface features within the first subregion having a first distribution of feature sizes and/or feature positions in at least one direction.

24. The method of claim 23, wherein heating the substrate comprises heating the substrate to a target temperature of at least 300° C.

25. The method of claim 23, further comprising wet etching the substrate by exposing the first surface and a second surface opposite the first surface to an etchant.

26. The method of claim 25, wherein the etchant comprises hydrofluoric acid.

27. The method of claim 25, wherein the etchant comprises an aqueous hydroxide material.

28. The method of claim 25, wherein the wet etching is configured to remove at most 20 μm from the first surface and a second surface of the substrate opposite the first surface.

29. The method of claim 28, wherein the wet etching is configured to remove at most 5 μm from the first surface and the second surface.

30. The method of claim 23, further comprising chemically strengthening the substrate through the first surface with the surface features and a second surface opposite the first surface.

31. The method of claim 30, wherein chemically strengthening the substrate is accomplished by an ion-exchange medium comprising a molten alkali salt.

32. The method of claim 23, wherein configuring the laser to emit the pulsed radiation to form the first subregion of surface features comprises setting one or more parameters of the laser, the parameters including a laser type, a center wavelength, a repetition rate, an average power, a pulse duration, a pulse energy, a beam shape, a focal length, a spot size, a scanning method, a scanning speed, a scanning pitch spacing, a scanning line spacing, and a laser fluence.

33. The method of claim 32, further comprising configuring the laser to emit the pulsed radiation to form a second subregion of surface features within the textured region, the surface features within the second subregion having a second distribution of feature sizes and/or feature positions in the at least one direction that is different than the first distribution of feature sizes and/or feature positions.

34. The method of claim 33, wherein configuring the laser to emit the pulsed radiation to form the second subregion of surface features comprises changing at least one of the one or more parameters of the laser.

35. A method of texturing an article, comprising:
heating a substrate that comprises a glass, glass-ceramic, or ceramic composition to a target temperature;
directing pulsed radiation from a laser at a first surface of the substrate to form a plurality of surface features within a textured region, the surface features each having a feature size and a feature position defined by the pulsed radiation; and
configuring the laser to emit the pulsed radiation to form at least one subregion of surface features within the textured region, the surface features within the at least one subregion having a continuous and random distribution of feature sizes and feature positions.
